(19) United States
(12) Patent Application Publication
(10) Pub. No.: US 2023/0184890 A1
(43) Pub. Date: Jun. 15, 2023

(54) INTENSITY-BASED LIDAR-RADAR TARGET

(71) Applicant: GM Cruise Holdings LLC, San Francisco, CA (US)

(72) Inventors: Daniel Chou, Sunnyvale, CA (US); Matthew Clayton Jones, Oakland, CA (US); Juan Fasola, San Francisco, CA (US)

(73) Assignee: GM Cruise Holdings LLC, San Francisco, CA (US)

(21) Appl. No.: 17/548,549

(22) Filed: Dec. 12, 2021

(51) Int. Cl. G01S 7/40; G01S 7/497; G01S 13/75; G01S 17/74

(52) U.S. Cl. CPC G01S 7/4082; G01S 7/497; G01S 13/75; G01S 17/74; G01S 17/931

(57) ABSTRACT

Apparatus and methods are provided for using a retroflected target for calibrating environmental geometric sensing systems. In particular, apparatus and methods are provided for unstructured calibrations using a plurality of spatial sensing data acquisitions and the data correlations thereof. In various implementations, a combined LiDAR-RADAR detector is used to associate one with the other. According to one aspect of the present disclosure, a predetermined LiDAR detector is used as a reference frame for RADAR segmentation. Specifically, a LiDAR point-of-interest is conveyed to RADAR system for unstructured calibration. To that end, RADAR and LiDAR can be calibrated with one another without the need for absolute positioning.

### FIELD OF THE DISCLOSURE

The present disclosure relates generally to the calibration of optical systems used in environment sensing. More specifically, the present disclosure pertains to the calibration of spatial sensing and acquisition found in autonomous vehicles.

### BACKGROUND

An autonomous vehicle (AV) is a vehicle that is configured to navigate roadways based upon sensor signals output by sensors of the AV, wherein the AV navigates the roadways without input from a human. The AV is configured to identify and track objects (such as vehicles, pedestrians, bicyclists, static objects, and so forth) based upon the sensor signals output by the sensors of the AV and perform driving maneuvers (such as accelerating, decelerating, turning, stopping, etc.) based upon the identified and tracked objects.

The use of automation in the driving of road vehicles such as cars and truck has increased as a result of advances in sensing technologies (e.g., object detection and location tracking), control algorithms, and data infrastructures. By combining various enabling technologies like adaptive cruise control (ACC), lane keeping assistance (LKA), electronic power assist steering (EPAS), adaptive front steering, parking assistance, antilock braking (ABS), traction control, electronic stability control (ESC), blind spot detection, GPS and map databases, vehicle to vehicle communication, and other, it becomes possible to operate a vehicle autonomously (i.e., with little or no intervention by a driver).

In the field of autonomous or quasi-autonomous operation of vehicles such as aircrafts, watercrafts or land vehicles, in particular automobiles, which may be manned or unmanned, sensing the surrounding of the vehicle as well as tracking objects in the surrounding of the vehicle may be considered to be important for sophisticated functionalities. These functionalities may range from driver assistance systems in different stages of autonomy up to full autonomous driving of the vehicle.

In the certain environments, a plurality of different types of sensors for sensing the surrounding of a vehicle are used, such as monoscopic or stereoscopic cameras, light detection and ranging (LiDAR) sensors, and radio detection and ranging (RADAR) sensors. The different sensor types comprise different characteristics that may be utilized for different tasks.

### SUMMARY

Apparatus and methods are provided for using a retroflected target for calibrating environmental geometric sensing systems. In particular, apparatus and methods are provided for unstructured calibrations using a plurality of spatial sensing data acquisitions and the data correlations thereof. In various implementations, a combined LiDAR-RADAR detector is to associate one with the other. According to one aspect of the present disclosure, a predetermined LiDAR detector is used as a reference frame for RADAR segmentation.

In physics and astronomy, a frame of reference (or reference frame) consists of an abstract coordinate system whose origin, orientation, and scale are specified by a set of reference points—geometric points whose position is identified both mathematically (with numerical coordinate values) and physically (signaled by conventional markers).

For n dimensions, n+1 reference points are sufficient to fully define a reference frame. Using rectangular (Cartesian) coordinates, a reference frame may be defined with a reference point at the origin and a reference point at one-unit distance along each of the n coordinate axe. Specifically, a LiDAR point-of-interest is conveyed to RADAR system for unstructured calibration. To that end, RADAR and LiDAR can be calibrated with one another without the need for absolute positioning.

According to one aspect, the present disclosure provides a target for calibration of spatial systems comprising: a first corner RADAR reflector comprising a retroreflective geometry; and an optical target comprising highly reflective material.

Spatial information is geographic and location-tagged information that's collected using thousands of sources—think global positioning satellites, land surveying, laser mapping, smart phones and vehicles. Spatial systems is the study of the science and technology of measurement, mapping and visualization of natural and built environments.

According to another aspect, the present disclosure provides a method for calibration of spatial systems comprising scanning an optical ranging system for a target; identifying the target; estimating the location of the target; searching for the target using RADAR; identifying the target using RADAR; estimating the location of the target of RADAR; and calibrating at least one of optical ranging system and RADAR based at least on the estimating estimations of target.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a diagram illustrating an example of an autonomous vehicle chassis having multiple optical sensors, according to various embodiments of the disclosure;

FIG. 3 is a diagram illustrating an example of an autonomous vehicle chassis having multiple optical sensors, according to various embodiments of the disclosure;

FIG. 4 depicts an exemplary corner reflector, according to some embodiments of the disclosure;

FIG. 5 shows an example embodiment of an apparatus for implementing certain aspects of the present technology;

FIG. 6 shows an exemplary alternate embodiment of an apparatus for implementing certain aspects of the present technology; and

FIGS. 7A-B shows an example embodiment of an apparatus for implementing certain aspects of the present technology.

### DETAILED DESCRIPTION

Overview

Apparatus, systems, and methods are provided for the calibration of optical systems used in environment sensing. More specifically, the present disclosure provides the correlation and calibration of spatial sensing and acquisition found in autonomous vehicles. When produced, spatial sensors and spatial sensor systems exhibit differences during production. Variances can stem from differences in manufacturing runs to doping of semiconductors materials. As such sensors require some calibration before installation. This is called intrinsic calibration.

Geometric calibration, also referred to as resectioning, estimates the parameters of image spatial sensor. Parameters are used to correct for distortion, measure the size of an object in world units, or determine the location of the spatial sensor in the scene. These tasks are used in applications such as machine vision to detect and measure objects. They are also used in robotics, for navigation systems, and 3-D scene reconstruction.

Sensor parameters include intrinsics, extrinsics, and distortion coefficients. To estimate the parameters, it is desired to have three-dimensional (3-D) world points to correspond to two-dimensional (2-D) image points. Typically, correspondences can be made using multiple images and/or target patterns. Using the correspondences, parameters can be solved. After a sensor is calibrated, accuracy is evaluated using the estimated parameters. Calculations comprise reprojection errors and parameter estimation error.

Intrinsic calibrations are burdensome and costly. Furthermore, intrinsic calibrations may not account for vehicle placement, application, disparities among sensors systems, or other unforeseen implementations. Extrinsic calibration aims to obtain the extrinsic parameters that define the rigid relationship, that is, the rotation matrix and translation vector between two coordinate systems. The inventors of the present disclosure contemplate the extrinsic calibrations by correlating two or more sensor systems.

Example Autonomous Vehicle Configured for Environmental Optical Sensing

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

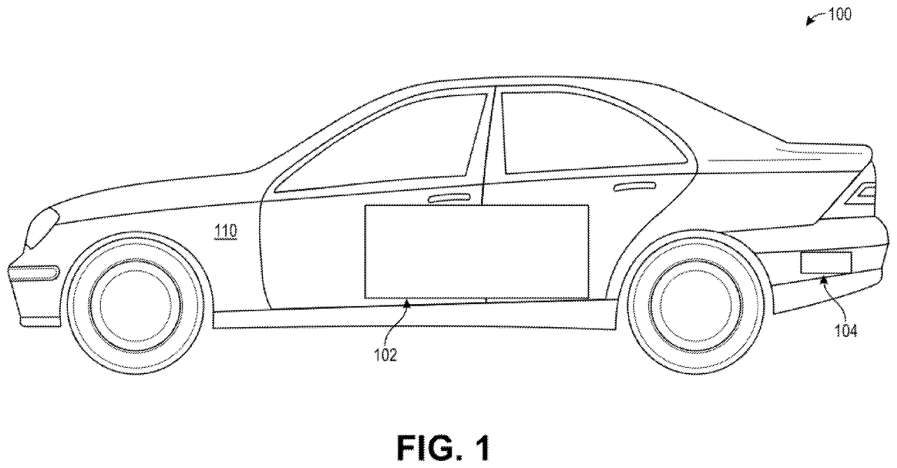

FIG. 1 is a diagram of an autonomous driving system 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, and to sense and avoid obstacles. According to various implementations, the autonomous vehicle 110 is part of a fleet of vehicles for picking up passengers and/or packages and driving to selected destinations.

The sensor suite 102 includes localization and driving sensors. For example, the sensor suite may include one or more of photodetectors, cameras, RADAR, sonar, LiDAR, GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment and, in some examples, sensor suite 102 data is used to detect selected events, and update a high-fidelity map. In particular, data from the sensor suite can be used to update a map with information used to develop layers with waypoints identifying selected events, the locations of the encountered events, and the frequency with which the events are encountered at the identified location. In some examples, the events include road hazard data such as locations of pot holes or debris. In this way, sensor suite 102 data from many autonomous vehicles can continually provide feedback to the mapping system and the high-fidelity map can be updated as more and more information is gathered.

The sensor suite 102 includes a plurality of sensors and is coupled to the onboard computer 104. In some examples, the onboard computer 104 receives data captured by the sensor suite 102 and utilizes the data received from the sensors suite 102 in controlling operation of the autonomous vehicle 110. In some examples, one or more sensors in the sensor suite 102 are coupled to the vehicle batteries, and capture information regarding a state of charge of the batteries and/or a state of health of the batteries.

In various examples, the sensor suite 102 includes cameras implemented using high-resolution imagers with fixed mounting and field of view. In further examples, the sensor suite 102 includes LiDARs implemented using scanning LiDARs. Scanning LiDARs have a dynamically configurable field of view that provides a point-cloud of the region intended to scan. In still further examples, the sensor suite 102 includes RADARs implemented using scanning RADARs with dynamically configurable field of view. In some examples, the sensor suite 102 records information relevant to vehicle structural health. In various examples, additional sensors are positioned within the vehicle, and on other surfaces on the vehicle. In some examples, additional sensors are positioned on the vehicle chassis.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface) and/or other interested parties (e.g., via a vehicle coordinator or a remote expert interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example Vehicle Front with Optical Sensors

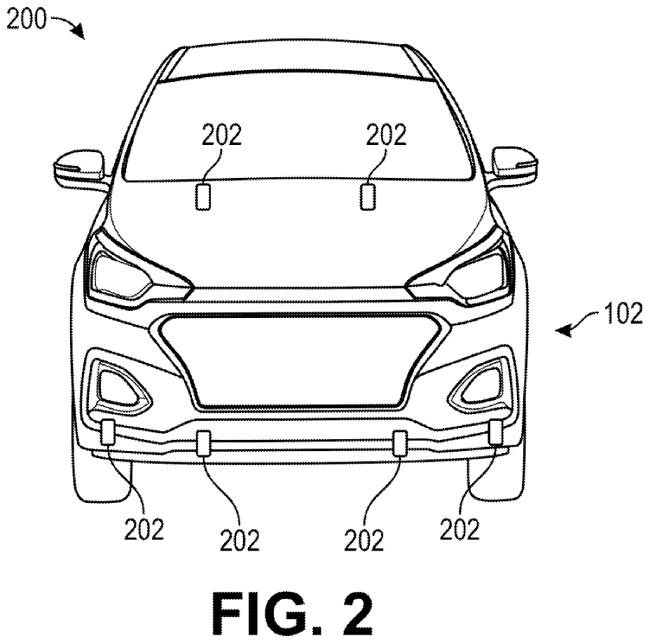

FIG. 2 is a diagram illustrating an example of a front of an autonomous vehicle 200 with multiple spatial systems 202, according to various embodiments of the invention. The spatial systems 202 can be positioned underneath the fascia of the vehicle, such that they are not visible from the exterior. In various implementations, more or fewer spatial systems 202 are included on the autonomous vehicle 200, and in various implementations, the spatial systems 202 are located in any selected position on or in the autonomous vehicle 200. The spatial systems 202 measure structural integrity of the frame and other structural elements of the autonomous vehicle 200, as described above. As described above with respect to the transducers 204 of FIG. 1, in various examples, one or more of the spatial systems 202 are LiDAR devices.

LiDAR is a method for determining ranges (variable distance) by targeting an object with a laser and measuring the time for the reflected light to return to the receiver. LiDAR can also be used to make digital 3-D representations of areas on the earth's surface and ocean bottom, due to differences in laser return times, and by varying laser wavelengths. It has terrestrial, airborne, and mobile applications. LiDAR is an acronym of “light detection and ranging” or “laser imaging, detection, and ranging”. LiDAR sometimes is called 3-D laser scanning, a special combination of 3-D scanning and laser scanning.

In other embodiments, time-of-flight (ToF) systems and such as an Red-Green-Blue (RGB) camera, can be implemented. A ToF camera is a range imaging camera system employing time-of-flight techniques to resolve distance between the camera and the subject for each point of the image, by measuring the round-trip time of an artificial light signal provided by a laser or a light emitting diode (LED). Laser-based ToF cameras are part of a broader class of scannerless LiDAR, in which the entire scene is captured with each laser pulse, as opposed to point-by-point with a laser beam such as in scanning LiDAR systems. ToF camera systems can cover ranges of a few centimeters up to several kilometers.

In yet other embodiments, calibration techniques are applicable to optical imaging which uses light and special properties of photons to obtain detailed images. Other applications, such as, spectroscopy, are also not beyond the scope of the present disclosure.

In various implementations, additional spatial systems 202 are positioned along the sides of an autonomous vehicle, and at the rear of the autonomous vehicle. These spatial systems 202 may be uses as individual devices or collaboratively, as in a plurality of differing types or an array of the same type, such as, a phased array.

Responses among the various spatial systems 202 are used by autonomous vehicles to determine the surrounding environment and moving with little or no human input. To that end, sensor suite 102 combines a variety of sensors to perceive vehicle surroundings, such as RADAR, LiDAR, sonar, GPS, odometry, and inertial measurement units. Advanced control systems interpret sensory information to identify appropriate navigation paths, as well as obstacles and relevant signage.

Example Vehicle with Differing Sensor Systems

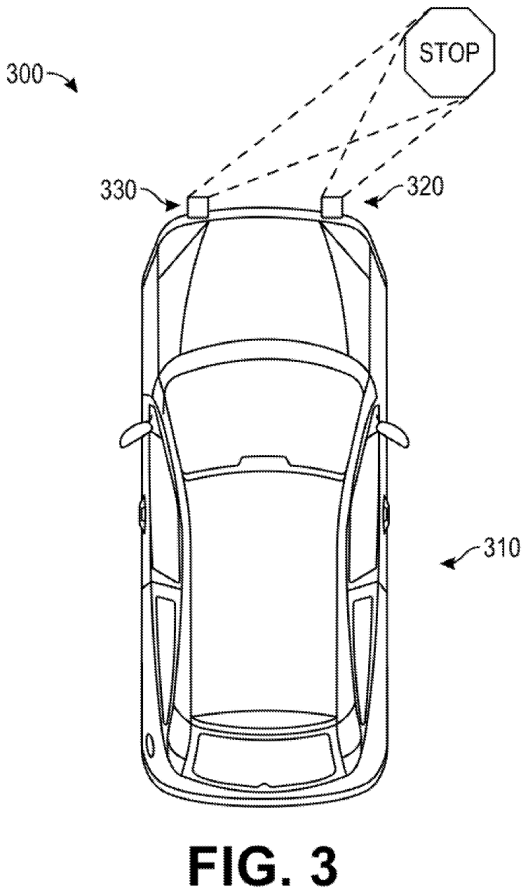

FIG. 3 is a diagram illustrating an example of a front of an autonomous vehicle 310 with multiple spatial systems, according to various embodiments of the invention. According to one embodiment, a first spatial system is LiDAR 320 and a second spatial system is RADAR 330. The inventors of present disclosure have identified a need in the art to combine sensor types as one or more sensor types may be more susceptible to error than others. Accordingly, they propose correlating multiple spatial types, such as, LiDAR with RADAR, while accounting for absolute position errors.

The combination of a RADAR and LiDAR can be widely used in robotics, mapping, and unmanned driving to simultaneously obtain the 3D geometry and landscape of a scene. However, data mis-registration between the RADAR and LiDAR frequently occurs due to the difficulty of precise installation and alignment between them. Extrinsic calibration between the LiDAR and RADAR is necessary. In the present disclosure, a RADAR-LiDAR target is used to perform a robust and accurate calibration between the LiDAR and RADAR which doesn't require absolute positioning knowledge of the target.

Embodiments of the present disclosure concern aspects of processing measurement data of RADAR systems, whereby the inaccuracies of sensor data (e.g., range, angle and velocity) can be calibrated. This is particularly useful, when two or more spatial sensing systems need to be extrinsically calibrated by correlation.

RADAR systems typically provide measurement data, in particular range, Doppler, and/or angle measurements (azimuth and/or elevation), with high precision in a radial direction. This allows one to accurately measure (radial) distances as well as (radial) velocities in a field of view of the RADAR system between different reflection points and the (respective) antenna of the RADAR system.

RADAR systems transmit (emit) RADAR signals into the RADAR system's field of view, wherein the RADAR signals are reflected off of objects that are present in the RADAR system's field of view and received by the RADAR system. The transmission signals are, for instance, frequency modulated continuous wave (FMCW) signals. Radial distances can be measured by utilizing the time-of-flight travel of the RADAR signal, wherein radial velocities are measured by utilizing the frequency shift caused by the Doppler Effect.

By repeating the transmitting and receiving of the RADAR signals, RADAR systems are able to observe the RADAR system's field of view over time by providing measurement data comprising multiple, in particular consecutive, RADAR frames. An individual RADAR frame may for instance be a range-azimuth-frame or a range-doppler-azimuth-frame. A range-Doppler-azimuth-elevation-frame would be also conceivable, if data in the elevation-direction is available.

In each of the multiple RADAR frames a plurality of reflection points which may form clouds of reflection points can be detected. However, the reflection points or point clouds, respectively, in the RADAR frames do not contain a semantic meaning per se. Accordingly, a semantic segmentation of the RADAR frames is necessary in order to evaluate (“understand”) the scene of the vehicle's surrounding.

The segmentation of a RADAR frame means that the single reflection points in the individual RADAR frames are assigned a meaning. For instance, reflection points may be assigned to the background of the scene, foreground of the scene, stationary objects such as buildings, walls, parking vehicles or parts of a road, and/or moving objects such as other vehicles, cyclists and/or pedestrians in the scene.

Generally, RADAR systems observe specular reflections of the transmission signals that are emitted from the RADAR system, since the objects to be sensed tend to comprise smoother reflection characteristics than the (modulated) wavelengths of the transmission signals. Consequently, the obtained RADAR frames do not contain continuous regions representing single objects, but rather single prominent reflection points (such as the edge of a bumper), distributed over regions of the RADAR frame.

RADAR data form of 3-dimensional, complex-valued array (a.k.a. RADAR cube) with dimensions corresponding to azimuth (angle), radial velocity (Doppler), and radial distance (range). Taking the magnitude in each angle-doppler-range bin describe how much energy the RADAR sensor sees coming from that point in space (angle and range) for that radial velocity.

Turning to FIG. 3, autonomous vehicle 310 comprises LiDAR 320 and RADAR 330. One problem in the art arises from the lateral offset between LiDAR 320 and RADAR 330. As can be appreciated by one skilled in the art, the coordinate origins for LiDAR 320 and RADAR 330 are not co-located thereby resulting a nominally different coordinate system. In the present embodiment, target (stop sign) is covered in highly reflected tape and exhibits other highly identifiable properties, such as, shape, conductivity, etc.

In practice during an unstructured calibration, LiDAR 320 scans the surrounding environment and identifies the stop sign. RADAR 330 uses this information to search for RADAR point clouds in the general location where the LiDAR 320 identified the target. Because LiDAR is accurate in ranging, the resulting information can be used to calibrate the RADAR 330, at least in part. Additionally, this makes processing the data permissible in a real time environment, as segmentation need only be performed the area identified by the LiDAR 320.

In some embodiments, the target comprises a retroreflective surface, at least in part. Retroreflection occurs when a surface returns a large portion of directed light beam back to its source. Retroreflective materials appear brightest to observers nearest the light source (such as a motorist). The object's brightness depends on the intensity of the light striking the object and the materials the object is made of. Predetermined patterns, such as, bars can be used to help identify a target. However, any shape and configuration are not beyond the scope of the present disclosure.

In some implementations, the retroreflective material comprises truncated cube or high intensity prismatic sign reflective sign sheeting which is noticeably brighter and more legible at a greater distance. In other implementations, glass-bead retroreflection target sheeting is used, wherein an incoming light beam bends as it passes through a glass-bead, reflects off a mirrored surface behind the bead, then the light bends again as it passes back through the bead and returns to the light source. In yet other implementations, cube corner retroreflection target sheeting is used. This technology returns light more efficiently than glass beads. With this technology, each cube corner has three carefully angled reflective surfaces. Incoming light bounces off all three surfaces and returns to its source.

While some embodiments implement retroreflective materials, mirror reflection and diffuse are not beyond the scope of the present disclosure.

Example Using Corner Reflector

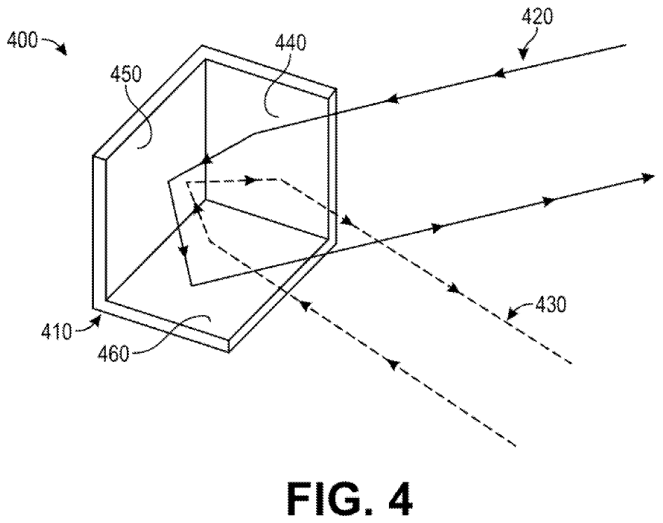

FIG. 4 depicts an exemplary corner reflector 410, according to some embodiments of the disclosure. A corner reflector is a retroreflector consisting of three mutually perpendicular, intersecting flat surfaces, which reflects waves directly towards the source, but translated. The three intersecting surfaces often have square or triangular shapes. RADAR corner reflectors made of metal are used to reflect radio waves from RADAR sets. Optical corner reflectors, called corner cubes or cube corners, made of three-sided glass prisms, are used in surveying and laser ranging.

In practice, an incoming ray 420 is reflected three times, once by each surface 440, 450, 460, which results in a reversal of direction. One skilled in the art can appreciate that the three corresponding normal vectors of the corner's perpendicular sides can be considered to form a basis (a rectangular coordinate system) (x, y, z) in which to represent the direction of an arbitrary incoming ray, 430. When the ray reflects from the surface 460, the ray's x component, is reversed while the y and z components are unchanged. Similarly, when reflected from surface 450 and finally from surface 460, all components are reversed. Therefore, an arbitrary ray 430 direction travels in leaves the corner reflector 410 with all three components of direction exactly reversed. The distance traveled, relative to a plane normal to the direction of the rays, is also equal for any ray entering the reflector, regardless of the location where it first reflects. The significance of corner reflectors will now be discussed in more detail.

The present embodiment depicts the partial or cross section of a cube. However, any suitable shape is not beyond the present disclosure, such as, cuboid, parallelepiped, rhomboid, etc.

Example Embodiment of a LiDAR-RADAR Target

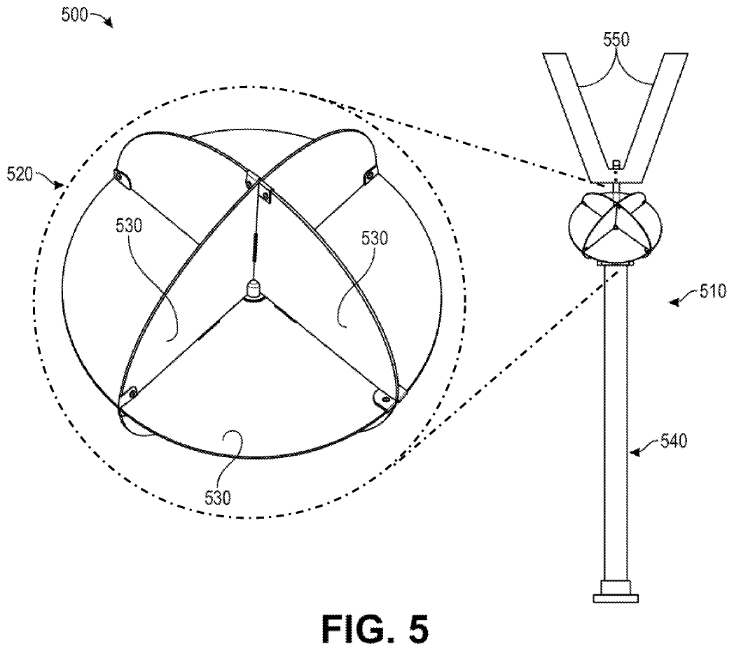

FIG. 5 shows an example embodiment 500 of an apparatus for implementing certain aspects of the present technology. As previously described, structured calibrations are costly and not always practical. Structured calibrations typically require a test setting with a multiple target at known distances and/or environmental geometries. With RADAR systems requiring long distances to achieve acceptable intrinsic calibrations, the test sight become unwieldy and inefficient, particularly when executing numerous vehicles.

The present disclosure generally relates to Millimeter Wave Sensing, while other wavelengths and applications are not beyond the scope of the invention. Specifically, the present method pertains to a sensing technology called FMCW RADARs, which is very popular in automotive and industrial segments. Turning to FIG. 5, RADAR reflector 520 comprises reflector sides 530.

RADAR reflectors, sometimes called RADAR Target Enhancers (RTEs), reflect RADAR energy from other RADARs so that the target shows up as a larger and more consistent “target.” As can be appreciated in the maritime arts, a boat in areas with shipping traffic or where fog and low visibility are common, the ability to be seen by RADAR-equipped ships can make the difference between being seen and being sunk.

Similar to the previous descriptions, RADAR reflectors work by reflecting RADAR energy directly back to the RADAR antenna so that the RADAR reflectors appears to be a larger target. This would be analogous to retroreflective dots on many highways that make it so much easier to see where the lanes are. These light reflectors use small triangular-shaped prisms that bounce the light around and reflect it precisely back at its source.

The effectiveness of a RADAR reflector is disproportionately related to its size. Assume that you have three theoretical reflectors of the same design, but of different sizes. This can be appreciated by a look at how rapidly the RADAR Cross Section (RCS) increases with size. The RCS of a given reflector goes up by the fourth power of the radius, resulting in this dramatic increase in effectiveness. For example, a reflector of twice the size of a similar but smaller model has an RCS that is 16-times larger.

In the present embodiment, reflector sides 530 make up a reflector corner, pursuant to the discussion associated with FIG. 4. In contrast to the single corner, one in the art can appreciate the broad observation angle of full plane. That is, any RADAR incident at or above the plane of the hemisphere will return a signal. Other configurations are not beyond the scope of the present disclosure.

To remind, a corner reflector is a passive device used to reflect radio waves back towards the emission source directly. Therefore, corner reflector is a useful device for RADAR system calibration. In general, the corner reflector consists mutually intersected perpendicular plates. Common corner reflectors comprise dihedral and trihedral. Corner reflectors are used to generate a particularly strong RADAR echo from objects that would otherwise have only very low effective RCS.

A corner reflector consisting of two or three electrically conductive surfaces which are mounted crosswise (at an angle of exactly 90 degrees). Incoming electromagnetic waves are backscattered by multiple reflection accurately in that direction from which they come. Thus, even small objects with small RCS yield a sufficiently strong echo. The larger a corner reflector is, the more energy is reflected. In some embodiments, tri-hederal shapes are implemented. Trihedral corner reflectors are popular canonical targets for Synthetic-Aperture RADAR (SAR) performance evaluation for many RADAR developments programs.

Also, not beyond the scope of the present disclosure, SAR is a form of RADAR that is used to create two-dimensional images or three-dimensional reconstructions of objects, such as landscapes. SAR uses the motion of the RADAR antenna over a target region to provide finer spatial resolution than conventional stationary beam-scanning RADARs. SAR is typically mounted on a moving platform, such as an aircraft or spacecraft, and has its origins in an advanced form of side looking airborne RADAR (SLAR).

The distance the SAR device travels over a target during the period when the target scene is illuminated creates the large synthetic antenna aperture (the size of the antenna). Typically, the larger the aperture, the higher the image resolution will be, regardless of whether the aperture is physical (a large antenna) or synthetic (a moving antenna)—this allows SAR to create high-resolution images with comparatively small physical antennas. For a fixed antenna size and orientation, objects which are further away remain illuminated longer—therefore SAR has the property of creating larger synthetic apertures for more distant objects, which results in a consistent spatial resolution over a range of viewing distances.

Turning back to FIG. 5, LiDAR-RADAR target 510 comprises RADAR reflector 520, post 540, and LiDAR target 550. LiDAR target 550 comprises retroreflective materials and exhibits a V-shape. Although not limiting, the inventors of the present disclosure have determined that V-shape is useful in identification, determination, and ranging of the target. For example, since the size of the V-shape is predetermined, the spatial sensing system can make an approximation of distance and therefore radial-azimuth (range-angle) window for the RADAR to look. In other words, a V-shape gives and contains a position in three-dimensional (3-D) space.

Similarly, each leg of the V-shape can be analyzed and accounted for, such as, in the case where the angle of incidence in non-orthogonal. The former benefits computational performance, whereas the latter behooves ranging accuracy. Nevertheless, the inventors of the preset disclosure have promulgated a synergy of calibrations which is long felt need in the art.

Post 540 is a main vertical or leaning support in a structure similar to a column or pillar. However, any suitable fixture or structure is not beyond the scope of present disclosure. In some embodiments, post 540 comprises retroreflective target sheeting. This can also be used to improve range accuracy, identification, and mitigation of segmentation processing.

Example Alternate Embodiment of a LiDAR-RADAR Target

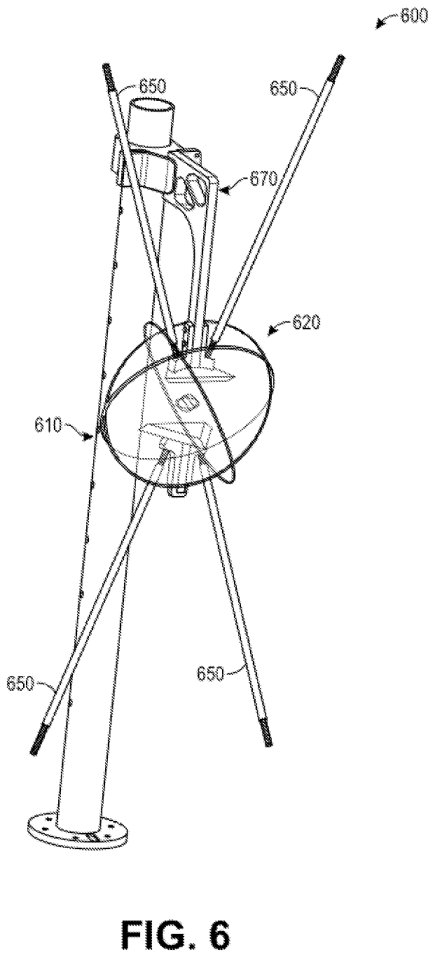

FIG. 6 shows an exemplary alternate embodiment of an apparatus for implementing certain aspects of the present technology. LiDAR-RADAR target 600 comprises post 610, RADAR target 620, LiDAR target 650, and bracket 670. LiDAR target 650 comprises retroreflective materials and exhibits an X-shape. Although not limiting, the inventors of the present disclosure have determined that X-shape is useful in identification, determination, and ranging of the target. For example, since the size of the X-shape is predetermined, the spatial sensing system can make an approximation of distance and therefore radial-azimuth (range-angle) window for the RADAR to look. In other words, an X-shape gives and contains a position in three-dimensional (3-D) space.

Similarly, each leg of the X-shape can be analyzed and accounted for, such as, in the case where the angle of incidence in non-orthogonal. The former benefits computational performance, whereas the latter behooves ranging accuracy. Nevertheless, the inventors of the preset disclosure have promulgated a synergy of calibrations which is long felt need in the art.

The present embodiment also includes a RADAR target 620 which has a 360-degree observational angle. Indeed, one of the arts can heuristically think of it as back-to-back 180-degree targets similar to those found in association with FIG. 5. In more practical terms, RADAR target 620 can return signals from anywhere substantially incident on a sphere.

Post 640 is a main vertical or leaning support in a structure similar to a column or pillar. However, any suitable fixture or structure is not beyond the scope of present disclosure. Bracket 670 serves to dispose RADAR target 620 in an orientation parallel to that of the post 640. But, in configuration is not beyond the scope of the present disclosure. In some embodiments, post 640 comprises retroreflective target sheeting. This can also be used to improve range accuracy, identification, and mitigation of segmentation processing.

While the present embodiment of the LiDAR target 650 is depicted in an X-shape, any open or closed shape, polyhedral, complex or otherwise, or polytype is not beyond the scope of the present disclosure. A polyhedron is a three-dimensional shape with flat polygonal faces, straight edges and sharp corners or vertices. A convex polyhedron is the convex hull of finitely many points, not all on the same plane.

A polytope is a geometric object with “flat” sides. It is a generalization in any number of dimensions of the three-dimensional polyhedron. Polytopes may exist in any general number of dimensions n as an n-dimensional polytope or n-polytope. In this context, flat sides mean that the sides of a (k+1)-polytope consist of k-polytopes that may have (k−1)-polytopes in common. For example, a two-dimensional polygon is a 2-polytope and a three-dimensional polyhedron is a 3-polytope.

Examples of 360-Degree LiDAR-RADAR Target

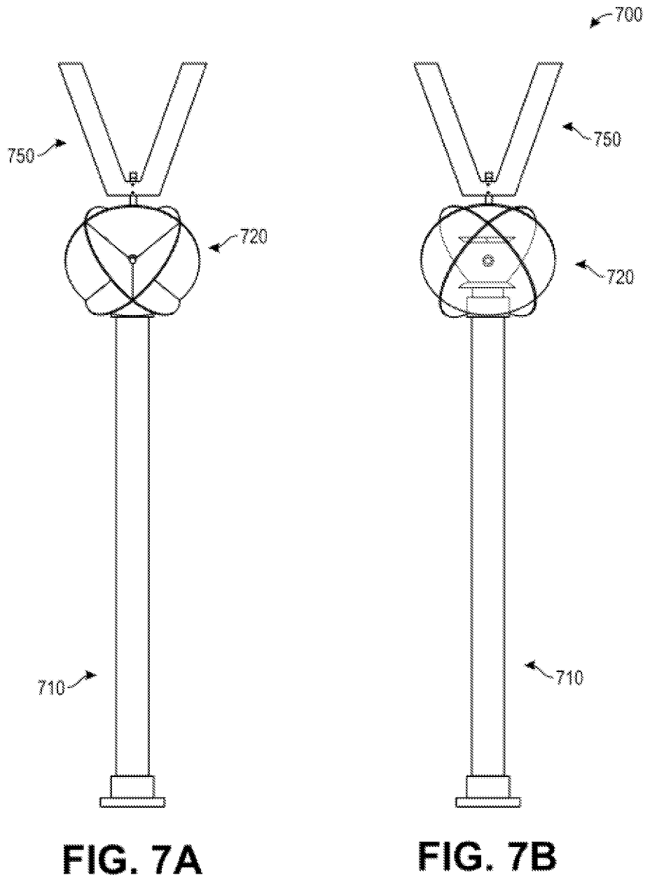

FIGS. 7A-B shows an example embodiment of an apparatus for implementing certain aspects of the present technology. For didactic purposes, FIG. 7A shows an opaque example embodiment of a 360-degree LiDAR-RADAR target 700, while FIG. 7B shows an exemplary schematic embodiment of a 360-degree LiDAR-RADAR target 700.

360-degree LiDAR-RADAR target 700 comprises post 710, RADAR target 720, LiDAR target 750, at least in part. LiDAR target 750 comprises retroreflective materials and exhibits a V-shape. Post 740 is a main vertical or leaning support in a structure similar to a column or pillar. RADAR target represents back-to-back 180-degree targets similar to those found in association with FIG. 5. In that, RADAR target 720 can return signals from anywhere substantially incident on a sphere.

While the inventors of the present disclosure recognize that the utilization and reflection of both the post 740 and LiDAR target 750 are helpful, both are non-limiting. Meaning, the advantages of the present disclosure can be yielded and cultivated by either. Additionally, other spatial sensing systems, such as, ToF, are also applicable implementations.

Time-of-flight is a property of an object, particle or acoustic, electromagnetic or other wave. It is the time that such an object needs to travel a distance through a medium. The measurement of this time (i.e. the time-of-flight) can be used for a time standard (such as an atomic fountain), as a way to measure velocity or path length through a given medium, or as a way to learn about the particle or medium (such as composition or flow rate). The traveling object may be detected directly (e.g., ion detector in mass spectrometry) or indirectly (e.g., light scattered from an object in laser Doppler velocimetry).

The time-of-flight principle is a method for measuring the distance between a sensor and an object based on the time difference between the emission of a signal and its return to the sensor after being reflected by an object. Various types of signals (also called carriers) can be used with ToF, the most common being sound and light. A ToF camera is a range imaging camera system that resolves distance based on the known speed of light, measuring the time-of-flight of a light signal between the camera and the subject for each point of the image.

Range gated imagers are devices which have a built-in shutter in the image sensor that opens and closes at the same rate as the light pulses are sent out. Because part of every returning pulse is blocked by the shutter according to its time of arrival, the amount of light received relates to the distance the pulse has traveled. As stated, sensing of the distance between a device and an object may be performed by emitting light from the device and measuring the time it takes for light to be reflected from the object and then collected by the device. A distance sensing device may include a light sensor which collects light that was emitted by the device and then reflected from objects in the environment.

In ToF three-dimensional (3D) image sensors, the image sensor captures a two-dimensional image. The image sensor is further equipped with a light source that illuminates objects whose distances from the device are to be measured by detecting the time it takes the emitted light to return to the image sensor. This provides the third dimension of information, allowing for generation of a 3D image. The use of a light source to illuminate objects for the purpose of determining their distance from the imaging device may utilize image processing techniques.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### SELECT EXAMPLES

Example 1 provides a target for calibration of spatial systems comprising: a first corner RADAR reflector comprising a retroreflective geometry; and an optical target comprising highly reflective material.

Example 2 provides a system according to one or more of the preceding and/or proceeding examples, wherein the first corner reflector is a retroreflector comprising at least three mutually perpendicular, intersecting flat surfaces.

Example 3 provides a system according to one or more of the preceding and/or proceeding examples, wherein the first corner reflector comprises a highly reflective RADAR surface.

Example 4 provides a system according to one or more of the preceding and/or proceeding examples further comprising a second, third, and fourth corner RADAR reflectors each comprising a retroreflective geometry.

Example 5 provides a system according to one or more of the preceding and/or proceeding examples, wherein the second, third, and fourth corner RADAR reflectors comprising a retroreflective geometry are disposed in a plane.

Example 6 provides a system according to one or more of the preceding and/or proceeding examples further comprising a fifth, sixth, seventh and eighth RADAR reflectors disposed in a plane opposite to the first, second, third and fourth RADAR reflectors.

Example 7 provides a system according to one or more of the preceding and/or proceeding examples, wherein the optical target comprises retroreflective material.

Example 8 provides a system according to one or more of the preceding and/or proceeding examples, wherein the retroreflective material comprises truncated cube optics.

Example 9 provides a system according to one or more of the preceding and/or proceeding examples, wherein the retroreflective material comprises glass-bead optics.

Example 10 provides a system according to one or more of the preceding and/or proceeding examples, wherein the optical target is shaped substantially like a V.

Example 11 provides a system according to one or more of the preceding and/or proceeding examples wherein the optical target is shaped substantially like a X.

Example 12 provides a system according to one or more of the preceding and/or proceeding examples further comprising a post comprising retroreflective material.

Example 13 provides a method for calibration of spatial systems comprising scanning an optical ranging system for a target; identifying the target; estimating the location of the target; searching for the target using RADAR; identifying the target using RADAR; estimating the location of the target of RADAR; and calibrating at least one of optical ranging system and RADAR based at least on the estimating estimations of target.

Example 14 provides a method according to one or more of the preceding and/or proceeding examples, wherein the optical ranging system comprises LiDAR.

Example 15 provides a method according to one or more of the preceding and/or proceeding examples, wherein the optical ranging system comprises time-of-flight.

Example 16 provides a method according to one or more of the preceding and/or proceeding examples, further comprising edge detecting.

Example 17 provides a method according to one or more of the preceding and/or proceeding examples, wherein the RADAR comprises frequency modulated continuous wave (FMCW) signals.

Example 18 provides a method according to one or more of the preceding and/or proceeding examples, wherein the target is retroreflective.

Example 19 provides a method according to one or more of the preceding and/or proceeding examples, wherein the retroreflective target is geometric.

Example 20 provides a method according to one or more of the preceding and/or proceeding examples, wherein the retroreflective target is optical.

Variations and Implementations

As will be appreciated by one skilled in the art, aspects of the present disclosure, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A target for calibration of spatial systems comprising:
a first corner RADAR reflector comprising a retroreflective geometry; and
an optical target comprising highly reflective material.

2. The target of claim 1, wherein the first corner RADAR reflector is a retroreflector comprising at least three mutually perpendicular, intersecting flat surfaces.

3. The target of claim 2, wherein the first corner RADAR reflector comprises a highly reflective RADAR surface.

4. The target of claim 1 further comprising a second, third, and fourth corner RADAR reflectors each comprising a retroreflective geometry.

5. The target of claim 4, wherein the second, third, and fourth corner RADAR reflectors comprising a retroreflective geometry are disposed in a plane.

6. The target of claim 5 further comprising a fifth, sixth, seventh and eighth RADAR reflectors disposed in a plane opposite to the first, second, third and fourth RADAR reflectors.

7. The target of claim 1, wherein the optical target comprises retroreflective material.

8. The target of claim 7, wherein the retroreflective material comprises truncated cube optics.

9. The target of claim 7, wherein the retroreflective material comprises glass-bead optics.

10. The target of claim 1, wherein the optical target is shaped substantially like a V.

11. The target of claim 1, wherein the optical target is shaped substantially like a X.

12. The target of claim 1 further comprising a post comprising retroreflective material.

13. A method for calibration of spatial systems comprising:
scanning an optical ranging system for a target;
identifying the target;
estimating a location of the target;
searching for the target using RADAR;
identifying the target using RADAR;
estimating the location of the target of RADAR; and
calibrating at least one of optical ranging system and RADAR based at least on the estimations of target.

14. The method of claim 13, wherein the optical ranging system comprises LiDAR.

15. The method of claim 13, wherein the optical ranging system comprises time-of-flight.

16. The method of claim 15 further comprising edge detecting.

17. The method of claim 13, wherein the RADAR comprises frequency modulated continuous wave (FMCW) signals.

18. The method of claim 13, wherein the target is retroreflective.

19. The method of claim 18, wherein the target is at least one of geometric and optical.

20. An apparatus for calibration of spatial systems comprising:
means for scanning an optical ranging system for a target;
means for identifying the target;
means estimating a location of the target;
means for searching for the target using RADAR;
means for identifying the target using RADAR;
means for estimating the location of the target of RADAR; and
means for calibrating at least one of optical ranging system and RADAR based at least on the estimations of target.
